(19) United States
(12) Patent Application Publication
(10) Pub. No.: US 2024/0391793 A1
(43) Pub. Date: Nov. 28, 2024

(54) PROCESS FOR PREPARING LUTETIUM-DOPED ZINC-FERRITE CERAMICS FOR HUMIDITY SENSOR APPLICATION AND ITS COMPOSITION THEREOF

(71) Applicants: Central Labs, AlQura'a (SA); King Khalid University, Abha (SA)

(72) Inventors: Mohd. Shkir, AlQura'a (SA); Jagadeesha Angadi V, Hubli (IN); S.M. Al-Moayid, AlQura'a (SA); Hamed Majdooa Algarni, AlQura'a (SA); Haitham Elhosiny Ali, AlQura'a (SA); Yasmin Khairy, AlQura'a (SA); Chatham Kumar B, Bangalore (IN); Mohd Ubaidullah, Punjab (IN); Kamlesh V. Chandekar, Navi Mumbai (IN)

(21) Appl. No.: 18/794,567

(22) Filed: Aug. 5, 2024

(51) Int. Cl. C01G 49/00; C09C 3/12; G01N 27/04

(52) U.S. Cl. CPC C01G 49/0063; C09C 3/12; C01P 2002/54; C01P 2002/72; C01P 2002/82; C01P 2004/64; C01P 2006/40; G01N 27/048

(57) ABSTRACT

The present invention relates to a process for preparing lutetium-doped zinc-ferrite ceramics for humidity sensor application and its composition thereof. This invention discloses a composition for lutetium-doped zinc ferrite ceramics, optimized for humidity sensor applications. The composition comprises specified weight percentages of zinc nitrate, iron nitrate, lutetium nitrate, glucose, urea, and optional distilled water. A corresponding synthesis process involves stoichiometric mixing, addition of glucose and urea, stirring with distilled water, and subsequent combustion in a preheated furnace. The ratio of lutetium varies from 0.00 to 0.07. The resulting ZnFe₍₂₋ₓ₎LuₓO₄ nanoparticles exhibit stability and uniformity, confirmed through XRD, FTIR, and SEM analyses. The humidity sensor performance is evaluated, with an optimized Lu=0.05 composition demonstrating a remarkable 93% sensing response. This composition and process offer potential for efficient and stable humidity sensors in various applications.

### FIELD OF THE INVENTION

The present disclosure relates to a process for preparing lutetium-doped zinc-ferrite ceramics for humidity sensor application and its composition thereof.

### BACKGROUND OF THE INVENTION

Ferrites, specifically spinel ferrite materials like ZnFe₍₂₋ₓ₎LuₓO₄, have garnered significant attention due to their exceptional dielectric and magnetic properties, making them valuable in energy storage and high-frequency applications. These materials typically have a general chemical formula AB₂O₄, where metal cations A and B occupy tetrahedral (A site) and octahedral (B site) positions, respectively. The arrangement of these metal cations within the crystal structure plays a pivotal role in determining the physical and chemical characteristics of ferrites.

In various industries, spinel ferrites (MFe₂O₄) find applications in gas sensors, electrode materials, microwave technology, environmental cleanup, and catalysis. The unique magnetic characteristics of single-phase spinel ferrite nanoparticles can be tailored by factors such as cation distribution, grain size, and shape, crucial for their performance in magneto-optical devices.

Rare-earth (RE) metal ions, including Gd³⁺, La³⁺, Nd³⁺, Sm³⁺, and Dy³⁺, have been employed as dopants in spinel ferrites to enhance their electromagnetic properties. The 4f electrons in f-f transitions of rare earth luminous materials contribute to properties such as high color purity, stable physical and chemical characteristics, and resistance to high-power electron beams.

These rare earth-doped ferrites exhibit potential for a wide range of applications, including transformer cores, chip inductors, information storage systems, ferrofluid applications, magneto-caloric refrigeration, and magnetic diagnostics. They offer high resistivity, saturation magnetization, low loss, and high initial permeability. Notably, zinc ferrite with an inverted spinel structure displays ferrimagnetic properties, further expanding its utility.

In the realm of sensor technology, there is a growing demand for small, cost-effective humidity sensors with improved repeatability, reproducibility, timing behavior, sensing responsiveness, lower detection limits, and room temperature operability. Conducting nanocomposite-based sensors are being explored for these applications, providing high sensitivity, simple production, room temperature operability, water absorption, compactness, and exceptional performance. Zn—Fe nanoparticles, due to their unique characteristics like low corrosion, cost-effectiveness, ease of preparation, environmental stability, and distinctive transport features, have gained attention.

However, challenges persist, particularly at higher relative humidity levels, prompting the need for improvements in timing behavior. Despite the multitude of research on various ferrite materials and their applications, there is currently a gap in knowledge regarding rare earth Lu-doped ferrites for humidity sensors. Therefore there is a need for an invention that addresses this gap by synthesizing ZnFe₍₂₋ₓ₎LuₓO₄ with varying Lu doping concentrations using a chemical synthesis method.

In the view of the foregoing discussion, it is clearly portrayed that there is a need of a process for preparing lutetium-doped zinc-ferrite ceramics for humidity sensor application and its composition thereof.

### SUMMARY OF THE INVENTION

The present disclosure relates to a process for preparing lutetium-doped zinc-ferrite ceramics for humidity sensor application and its composition thereof. The invention pertains to a process for preparing lutetium-doped zinc ferrite (ZnFe₍₂₋ₓ₎LuₓO₄) ceramics specifically designed for humidity sensor applications, along with the composition used in this process. The composition comprises zinc nitrate (Zn(NO₃)₂·6H₂O), iron nitrate (Fe(NO₃)₂·6H₂O), lutetium nitrate (Lu(NO₃)₂·9H₂O), glucose, urea, and optional distilled water. The molar ratio of these components ensures the stoichiometry required for the desired ceramics. The process involves mixing stoichiometric amounts of metal nitrates in a beaker, adding glucose and urea to form a redox mixture, and subsequently introducing distilled water to create a homogeneous solution. This solution undergoes combustion in a preheated muffle furnace at 450° C., leading to gel formation and powder release, resulting in the formation of ZnFe₍₂₋ₓ₎LuₓO₄ (where x=0.00, 0.01, 0.03, 0.05, 0.07) nanoparticles. The ratio of lutetium (Lu) in the composition can vary from 0.00 to 0.07, allowing for flexibility in the dopant concentration. The combustion process is facilitated by the preheated muffle furnace, and the resulting nanoparticles exhibit potential for humidity sensor applications. The process can be conducted under an inert atmosphere to prevent oxidation of the nanoparticles. After completion, the obtained powder undergoes cooling, washing, and drying to remove any impurities or by-products. This invention introduces a novel and efficient method for synthesizing lutetium-doped zinc ferrite ceramics tailored for humidity sensor applications, offering a controlled composition and a reproducible process for producing ZnFe₍₂₋ₓ₎LuₓO₄ nanoparticles with varying Lu concentrations.

The present disclosure seeks to provide a composition for preparing lutetium-doped zinc-ferrite ceramics for humidity sensor application. The composition comprises: 30-35 wt. % of zinc nitrate (Zn(NO₃)₂·6H₂O); 30-35 wt. % of iron nitrate (Fe(NO₃)₂·6H₂O); 30-35 wt. % of lutetium nitrate (Lu(NO₃)₂·9H₂O); 45-55 wt. % of glucose; 45-55 wt. % of urea; and 0-10 wt. % of distilled water.

In an embodiment, the weight percentage of the zinc nitrate (Zn(NO₃)₂·6H₂O), iron nitrate (Fe(NO₃)₂·6H₂O), lutetium nitrate (Lu(NO₃)₂·9H₂O), glucose, and urea is 33.33%, 33.33%, and 33.33%, 50%, and 50%, respectively, wherein the distilled water is preferably 15 mL.

The present disclosure also seeks to provide a process for preparing lutetium-doped zinc-ferrite ceramics for humidity sensor application. The process comprises: mixing stoichiometric molar amounts of 30-35 wt. % of zinc nitrate (Zn(NO₃)₂·6H₂O), 30-35 wt. % of iron nitrate (Fe(NO₃)₂·6H₂O), and 30-35 wt. % of lutetium nitrate (Lu(NO₃)₂·9H₂O) in a 250 ml beaker to obtain a mixture; adding glucose and urea in a 1:1 ratio to the mixture; adding 15 mL of distilled water to the mixture and stirring to obtain a homogeneous solution containing a redox mixture; and placing the beaker containing the solution in a preheated muffle furnace at 450° C. for approximately 30 minutes for a gel formation which subsequently burns into powder, releasing stable gases such as CO₂, N₂, and H₂O.

In an embodiment, the ratio of lutetium (Lu) varies from 0.00 to 0.07.

In an embodiment, the gel formation and subsequent powder formation occur due to the combustion of the redox mixture composed of metal nitrates, glucose, and urea, wherein combustion parameters, including nature of fuel, oxidizer, and combustion temperature, are optimized to promote formation of stable nanoparticles.

In an embodiment, the preheated muffle furnace facilitates the combustion process leading to the formation of ZnFe₍₂₋ₓ₎LuₓO₄ (Where X=0.00, 0.01, 0.03, 0.05, 0.07) (ZFL) nanoparticles.

In an embodiment, the zinc nitrate (Zn(NO₃)₂·6H₂O), iron nitrate (Fe(NO₃)₂·6H₂O), and lutetium nitrate (Lu(NO₃)₂·9H₂O) is preferably in a 1:1:1 ratio, wherein the glucose and urea are preferably in a 1:1 ratio.

In an embodiment, the process further comprises cooling the obtained powder to room temperature after the combustion process is complete.

In an embodiment, the combustion process is conducted under an inert atmosphere to prevent oxidation of the nanoparticles.

In an embodiment, the process further comprises washing and drying the obtained nanoparticles to remove any residual impurities or by-products.

An objective of the present disclosure is to provide a process for preparing lutetium-doped zinc-ferrite ceramics for humidity sensor application and its composition thereof.

Another objective of the present disclosure is to provide a composition for preparing lutetium-doped zinc ferrite ceramics with specific weight percentages of zinc nitrate, iron nitrate, lutetium nitrate, glucose, urea, and optional distilled water. This composition ensures stoichiometric precision and reproducibility in the synthesis process.

Another objective of the present disclosure is to introduce a process for preparing lutetium-doped zinc ferrite ceramics that involves mixing stoichiometric molar amounts of metal nitrates, glucose, and urea, leading to gel formation and subsequent powder release. This process facilitates the controlled formation of ZnFe₍₂₋ₓ₎LuₓO₄ nanoparticles, where x can vary from 0.00 to 0.07.

Another objective of the present disclosure is to employ a preheated muffle furnace for the combustion process, ensuring efficient gel formation and powder release. This furnace plays a crucial role in the synthesis of ZnFe₍₂₋ₓ₎LuₓO₄ nanoparticles with enhanced humidity-sensing properties.

Another objective of the present disclosure is to offer a composition and process adaptable to varying concentrations of lutetium (Lu) as a dopant, allowing for the customization of ZnFe₍₂₋ₓ₎LuₓO₄ nanoparticles for different humidity sensor applications.

Another objective of the present disclosure is to conduct the combustion process under an inert atmosphere, preventing oxidation of the nanoparticles and ensuring the integrity of the lutetium-doped zinc ferrite ceramics.

Another objective of the present disclosure is to provide a cooling, washing, and drying step in the process to eliminate any residual impurities or by-products, resulting in purified ZnFe₍₂₋ₓ₎LuₓO₄ nanoparticles suitable for humidity sensor applications.

Yet, another objective of the present disclosure is to contribute to the field of humidity sensor technology by offering lutetium-doped zinc ferrite ceramics with controlled composition and reproducible synthesis process, addressing the need for reliable and efficient humidity sensors.

To further clarify advantages and features of the present disclosure, a more particular description of the invention will be rendered by reference to specific embodiments thereof, which is illustrated in the appended drawings. It is appreciated that these drawings depict only typical embodiments of the invention and are therefore not to be considered limiting of its scope. The invention will be described and explained with additional specificity and detail with the accompanying drawings.

### BRIEF DESCRIPTION OF FIGURES

These and other features, aspects, and advantages of the present disclosure will become better understood when the following detailed description is read with reference to the accompanying drawings in which like characters represent like parts throughout the drawings, wherein:

FIG. 1 illustrates a flow chart of a process for preparing lutetium-doped zinc-ferrite ceramics for humidity sensor application in accordance with an embodiment of the present disclosure;

FIG. 2 illustrates a graphical representation for preparation of nanoparticles in accordance with an embodiment of the present disclosure;

FIG. 3 illustrates a graph showing XRD patterns of ZnFe₍₂₋ₓ₎LuₓO₄ (Where X=0.00, 0.01, 0.03, 0.05, 0.07) in accordance with an embodiment of the present disclosure;

FIG. 4 illustrates a crystallite size v/s concentration graph in accordance with an embodiment of the present disclosure;

FIG. 5 illustrates a graph showing FTIR spectra of Lu doped Zn ferrite in accordance with an embodiment of the present disclosure;

FIG. 6A represents microstructure analysis, wherein (a) represents Lu 0.00=ZnFe₂O₄, (b) represents Lu 0.01=ZnFe_{1.99}Lu_{0.01}O₄, nad figure (c) represents Lu 0.03=ZnFe_{1.97}Lu_{0.03}O₄;

FIG. 6B represents microstructure analysis, wherein (d) represents Lu 0.05=ZnFe_{1.95}Lu_{0.05}O₄, and (e) represents Lu 0.07=ZnFe_{1.93}Lu_{0.07}O₄.

FIG. 7 illustrates a diagram showing the humidity sensing study setup in accordance with an embodiment of the present disclosure;

FIG. 8 illustrates a graph depicting the change in resistance versus % RH in accordance with an embodiment of the present disclosure;

FIG. 9 illustrates a graphs depicting the sensing response of ZnFe₍₂₋ₓ₎LuₓO₄ where (X=0.00,0.01,0.03,0.05,0.07) in accordance with an embodiment of the present disclosure;

FIG. 10 illustrates a graph depicting the timing behavior of ZnFe_{1.95}Lu_{0.05}O₄ nanoparticles in accordance with an embodiment of the present disclosure;

FIG. 11 illustrates a graph depicting the humidity hysteresis of the ZnFe_{1.95}Lu_{0.05}O₄ nanoparticles in accordance with an embodiment of the present disclosure;

FIG. 12 illustrates a graph depicting the humidity stability of the ZnFe_{1.95}Lu_{0.05}O₄ nanoparticles in accordance with an embodiment of the present disclosure;

FIG. 13 illustrates a Graphical representation for the preparation of nanoparticles in accordance with an embodiment of the present disclosure;

FIG. 14 illustrates a Table depicting stoichiometric amount of oxidiser and fuels used in the synthesis method in accordance with an embodiment of the present disclosure; and

FIG. 15 illustrates a Table depicting the parameter of Zn Fe₂₋ₓLuₓO₄ in accordance with an embodiment of the present disclosure.

Further, skilled artisans will appreciate that elements in the drawings are illustrated for simplicity and may not have been necessarily been drawn to scale. For example, the flow charts illustrate the method in terms of the most prominent steps involved to help to improve understanding of aspects of the present disclosure. Furthermore, in terms of the construction of the device, one or more components of the device may have been represented in the drawings by conventional symbols, and the drawings may show only those specific details that are pertinent to understanding the embodiments of the present disclosure so as not to obscure the drawings with details that will be readily apparent to those of ordinary skill in the art having benefit of the description herein.

### DETAILED DESCRIPTION

For the purpose of promoting an understanding of the principles of the invention, reference will now be made to the embodiment illustrated in the drawings and specific language will be used to describe the same. It will nevertheless be understood that no limitation of the scope of the invention is thereby intended, such alterations and further modifications in the illustrated system, and such further applications of the principles of the invention as illustrated therein being contemplated as would normally occur to one skilled in the art to which the invention relates.

It will be understood by those skilled in the art that the foregoing general description and the following detailed description are exemplary and explanatory of the invention and are not intended to be restrictive thereof.

Reference throughout this specification to “an aspect”, “another aspect” or similar language means that a particular feature, structure, or characteristic described in connection with the embodiment is included in at least one embodiment of the present disclosure. Thus, appearances of the phrase “in an embodiment”, “in another embodiment” and similar language throughout this specification may, but do not necessarily, all refer to the same embodiment.

The terms “comprises”, “comprising”, or any other variations thereof, are intended to cover a non-exclusive inclusion, such that a process or method that comprises a list of steps does not include only those steps but may include other steps not expressly listed or inherent to such process or method. Similarly, one or more devices or sub-systems or elements or structures or components proceeded by “comprises . . . a” does not, without more constraints, preclude the existence of other devices or other sub-systems or other elements or other structures or other components or additional devices or additional sub-systems or additional elements or additional structures or additional components.

Unless otherwise defined, all technical and scientific terms used herein have the same meaning as commonly understood by one of ordinary skill in the art to which this invention belongs. The system, methods, and examples provided herein are illustrative only and not intended to be limiting.

Embodiments of the present disclosure will be described below in detail with reference to the accompanying drawings.

The present invention aims to provide a composition for preparing lutetium-doped zinc ferrite ceramics for humidity sensor application, the composition comprises: 30-35 wt. % of zinc nitrate (Zn(NO₃)₂·6H₂O); 30-35 wt. % of iron nitrate (Fe(NO₃)₂·6H₂O); 30-35 wt. % of lutetium nitrate (Lu(NO₃)₂·9H₂O); 45-55 wt. % of glucose; 45-55 wt. % of urea; and 0-10 wt. % of distilled water.

In an embodiment, the weight percentage of the zinc nitrate (Zn(NO₃)₂·6H₂O), iron nitrate (Fe(NO₃)₂·6H₂O), lutetium nitrate (Lu(NO₃)₂·9H₂O), glucose, and urea is 33.33%, 33.33%, and 33.33%, 50%, and 50%, respectively, wherein the distilled water is preferably 15 mL.

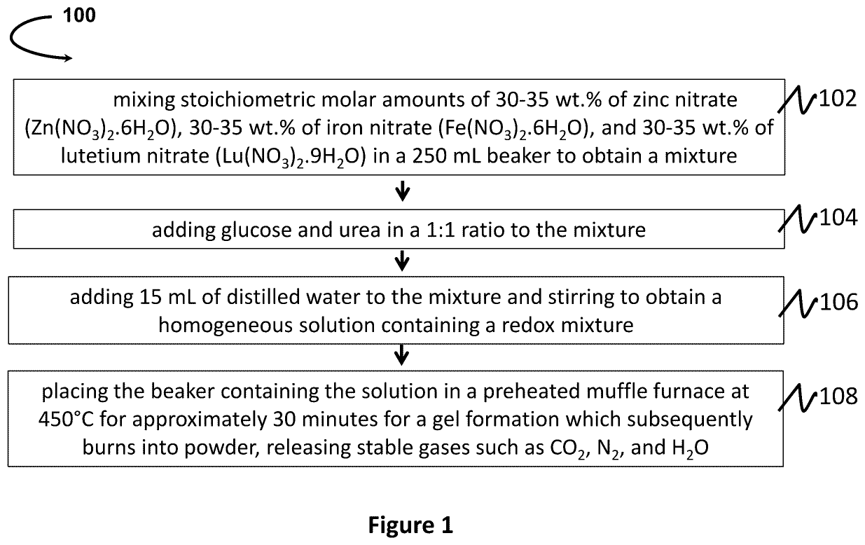

FIG. 1 illustrates a flow chart of a process for preparing lutetium-doped zinc-ferrite ceramics for humidity sensor application in accordance with an embodiment of the present disclosure.

Referring to FIG. 1, the process (100) includes plurality of steps as described below,

At step (102), the process (100) includes mixing stoichiometric molar amounts of 30-35 wt. % of zinc nitrate (Zn(NO₃)₂·6H₂O), 30-35 wt. % of iron nitrate (Fe(NO₃)₂·6H₂O), and 30-35 wt. % of lutetium nitrate (Lu(NO₃)₂·9H₂O) in a 250 ml beaker to obtain a mixture.

At step (104), the process (100) includes adding glucose and urea in a 1:1 ratio to the mixture.

At step (106), the process (100) includes adding 15 mL of distilled water to the mixture and stirring to obtain a homogeneous solution containing a redox mixture.

At step (108), the process (100) includes placing the beaker containing the solution in a preheated muffle furnace at 450° C. for approximately 30 minutes for a gel formation which subsequently burns into powder, releasing stable gases such as CO₂, N₂, and H₂O.

In an embodiment, the ratio of lutetium (Lu) varies from 0.00 to 0.07.

In an embodiment, the gel formation and subsequent powder formation occur due to the combustion of the redox mixture composed of metal nitrates, glucose, and urea, wherein combustion parameters, including nature of fuel, oxidizer, and combustion temperature, are optimized to promote formation of stable nanoparticles.

In an embodiment, the preheated muffle furnace facilitates the combustion process leading to the formation of ZnFe₍₂₋ₓ₎LuₓO₄ (Where X=0.00, 0.01, 0.03, 0.05, 0.07) (ZFL) nanoparticles.

In an embodiment, the zinc nitrate (Zn(NO₃)₂·6H₂O), iron nitrate (Fe(NO₃)₂·6H₂O), and lutetium nitrate (Lu(NO₃)₂·9H₂O) is preferably in a 1:1:1 ratio, wherein the glucose and urea are preferably in a 1:1 ratio.

In an embodiment, the process (100) further comprises cooling the obtained powder to room temperature after the combustion process is complete.

In an embodiment, the combustion process is conducted under an inert atmosphere to prevent oxidation of the nanoparticles.

In an embodiment, the process (100) further comprises washing and drying the obtained nanoparticles to remove any residual impurities or by-products.

In an embodiment, the homogeneous solution is stirred using a magnetic stirrer at 500 rpm for 15 minutes, wherein the distilled water added to the mixture is deionized and has a conductivity of less than 0.1 μS/cm, wherein the mixture is subjected to ultrasonic agitation for 5 minutes before adding the distilled water to ensure complete dissolution of nitrates, and wherein the muffle furnace is equipped with a thermocouple to monitor and control the temperature precisely at 450° C., and wherein the gel formation occurs within the first 15 minutes of heating in the muffle furnace.

In an embodiment, the process further comprising the step of aging the homogeneous solution at room temperature for 24 hours prior to combustion to enhance the homogeneity of the mixture and improve the uniformity of the final nanoparticles.

In an embodiment, the glucose and urea are dissolved separately in distilled water and then sequentially added to the metal nitrate mixture under continuous stirring at 300 rpm to ensure even distribution of the fuel and oxidizer components, and wherein the combustion process in the muffle furnace is conducted in a stepwise manner, starting with an initial heating at 200° C. for 10 minutes followed by a ramp-up to 450° C. to ensure controlled decomposition and combustion of the redox mixture.

In an embodiment, the process comprising subjecting the beaker containing the redox mixture to ultrasonic agitation for 15 minutes before placing it in the muffle furnace to break down any agglomerates and ensure a more homogeneous solution, and ball milling the calcined powder in a high-energy planetary ball mill for 3 hours at a speed of 400 rpm using zirconia balls to achieve a narrow particle size distribution and enhance the surface area.

In an embodiment, the ball-milled powder is subjected to a secondary calcination step at 700° C. for 2 hours in an inert atmosphere to further enhance the crystallinity and phase stability of the nanoparticles.

In an embodiment, the process further comprising pressing the ball-milled and calcined powder into cylindrical pellets using a uniaxial hydraulic press at a pressure of 500 MPa, followed by sintering in a box furnace at 950° C. for 6 hours with a heating rate of 5° C./min, and wherein the obtained nanoparticles are dispersed in ethanol and subjected to sonication for 30 minutes to achieve a stable colloidal suspension, followed by drop-casting onto interdigitated electrodes to fabricate a prototype humidity sensor.

In an embodiment, the process further comprising performing a detailed thermal analysis of the redox mixture using thermogravimetric analysis (TGA) and differential scanning calorimetry (DSC) to understand the thermal decomposition behavior and optimize the combustion process, and wherein the synthesized ZnFe(2-x)LuxO4 nanoparticles are functionalized with a silane coupling agent including 3-Aminopropyltriethoxysilane to improve the adhesion and stability of the nanoparticles on the sensor substrate.

A more detailed description of the process for preparing the aforementioned lutetium-doped zinc ferrite ceramics for humidity sensor application is described below.

Nanoparticles of ZnFe₍₂₋ₓ₎LuₓO₄ (where x=0.00, 0.01, 0.03, 0.05, 0.07) (referred to as ZFL) were synthesized using a chemical synthesis method. The synthesis process involved combining stoichiometric molar quantities of zinc nitrate (Zn(NO₃)₂·6H₂O), iron nitrate (Fe(NO₃)₂·6H₂O), and lutetium nitrate (Lu(NO₃)₂·9H₂O) in a 250 ml beaker as oxidizers. A 1:1 ratio of glucose and urea was added to this mixture, along with 15 mL of distilled water. The resulting mixture was stirred to achieve a homogeneous solution containing a redox mixture.

Subsequently, the beakers containing solutions comprising metal nitrates and fuels were positioned within a preheated muffle furnace set at 450° C. for approximately 30 minutes. Initially, the solution underwent boiling and ignition, resulting in the formation of a gel that eventually combusted into powder. During this process, stable gases such as CO₂, N₂, and H₂O were released. The redox reactions occurring during this phase can be succinctly expressed through the proposed Equation-1 provided below.

(2-x)Fe(NO₃)₂·6H₂O+xLu(NO₃)₂·9H₂O+Zn(NO₃)₂·6H₂O+C₆H₁₂O₆+NH₂CONH₂→ZnFe₍₂₋ₓ₎LuₓO4+4NO₂+7CO₂+4NH₃+20H₂O+3H₂ (1)

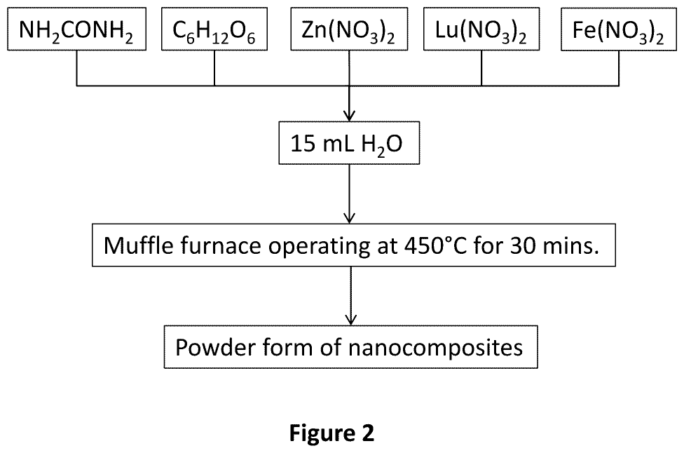

FIG. 2 illustrates a graphical representation for preparation of nanoparticles in accordance with an embodiment of the present disclosure. Referring to FIG. 2, a graphical representation of the detailed process as mentioned above is illustrated.

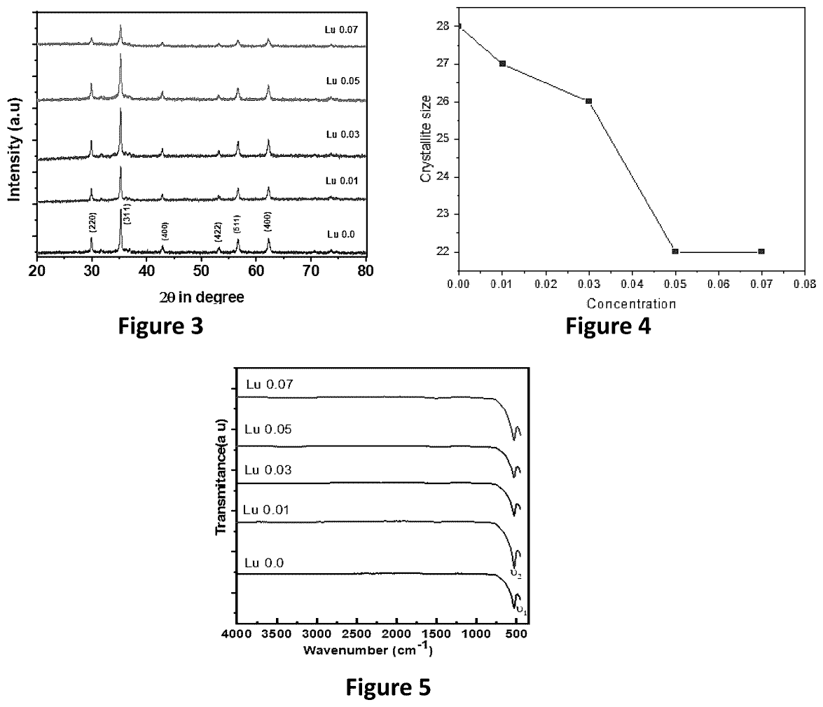

FIG. 3 illustrates a graph showing XRD patterns of ZnFe(2-x)LuₓO₄ (Where X=0.00, 0.01, 0.03, 0.05, 0.07) in accordance with an embodiment of the present disclosure.

Referring to FIG. 3, a structure and phase analysis is shown, wherein The XRD patterns of ZnFe₍₂₋ₓ₎LuₓO₄ (Where X=0.00, 0.01, 0.03, 0.05, 0.07) is represented. X-ray diffraction (XRD) patterns were obtained in the 2θ range of 20° to 80° at an optimal temperature. The presence of well-defined cubic characteristic peaks, namely (220), (311), (222), (400), (422), (511), and (440) at 29.90, 35.20, 42.60, 53.20, 56.70, and 62.26 in the XRD diffraction patterns for all samples, affirms the purity of the prepared samples, indicating the absence of any impurities. These distinct peaks serve as confirmation of both the excellent crystallinity and the cubic spinel structure in the synthesized materials.

FIG. 4 illustrates a crystallite size v/s concentration graph in accordance with an embodiment of the present disclosure.

Utilizing Equation 2 provided below, the average crystallite sizes of the prepared nanoparticles were determined, ranging from 28 to 22 nm. It was observed that the crystalline size exhibited a decrease with an increase in Lu3+ concentration. Previous investigations have indicated that the introduction of rare-earth ions with substantial radii, such as Lutetium (3+), into Zinc ferrites, replacing ferric ions, induces considerable strain and leads to a reduction in crystallite size.

$$D = \frac{( K \cdot λ )}{( β \cdot cos θ )} \qquad ( 2 )$$

Where,
   D—crystallite size (nm),
   K—Scherrer constant (0.89),
   λ—wavelength,
   β—full width half maximum in radians,
   θ—Bragg's angle.

As the ion concentration increases, a difference in radius between the dopant and the replaced element induces lattice distortion, potentially leading to a reduction in crystalline size. FIG. 4 illustrates the relationship between crystallite size and Lu concentration, highlighting the observed trend as ion concentration varies.

Further Lattice constant (a) is calculated using Equation 3.

$$a = \frac{λ \sqrt{{h}^{2} + {l}^{2} + {k}^{2}}}{2 Sin θ} \qquad ( 3 )$$

$$Where ,$$

$$\frac{λ}{2 sin θ} = {d}_{h k 1} ( interlunar spacing ) ,$$

h, k, l, are miller indices.

As the concentration of rare earth increases, the lattice parameter experiences a decrease, accompanied by a reduction in crystallite size. The substitution of Lu3+ in Zn ferrite induces a decrease in the lattice parameter, attributed to micro-strain within the internal grain region. This micro-strain is generated by compression, arising from variations in the thermal expansion coefficient between constituent elements or lattice mismatches between the grain and the grain boundary phase.

Unit cell volume (V) was calculated using Equation 4 below:

$$V = {a}^{3} \qquad ( 4 )$$

The distance between the magnetic ions at tetrahedral (A) and octahedral (B) sites were calculated by using the following equation 5 and 6.

$$La = \frac{a \sqrt{3}}{4} \qquad ( 5 )$$

$$Lb = \frac{a \sqrt{3}}{2} \qquad ( 6 )$$

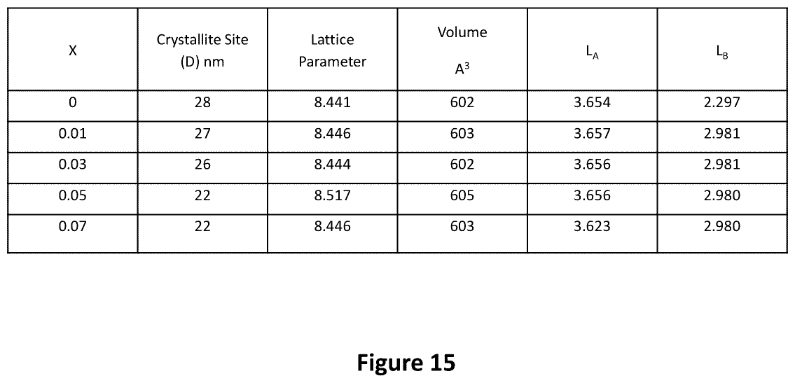

As the nanoparticle concentration rises, an increasing number of particles engage in interactions, leading to volume expansion as they aggregate or form clusters. However, at extremely high concentrations, the particles become densely packed, leaving insufficient space for additional particles to contribute to the volume. Consequently, the volume experiences a decrease, following the typical trend observed, as indicated by the values presented in Table illustrated in FIG. 15.

FIG. 5 illustrates a graph showing FTIR spectra of Lu doped Zn ferrite in accordance with an embodiment of the present disclosure.

In FIG. 5, the FTIR spectrum for ZnFe₍₂₋ₓ₎LuₓO₄ (Where X=0.00, 0.01, 0.03, 0.05, 0.07) reveals distinct absorption bands at 532 cm-1 (υ1) and 480 cm-1 (υ2), corresponding to tetrahedral and octahedral complexes, respectively. These bands signify the Fe—O bond lengths at the A-sites (tetrahedral) and B-sites (octahedral), with the difference between the υ1 and υ2 modes attributed to alterations in bond lengths. The positions of υ1 and υ2 are influenced by factors such as the preparation process, grain size, and porosity.

The absence of splitting or shouldering in the absorption band υ1 excludes the presence of Fe²⁺ ions at A-sites. Conversely, the observed splitting or shoulders in the absorption band υ2 are attributed to Jahn Teller distortion induced by Fe²⁺ ions on B-sites, causing lattice deformation due to a non-cubic component in the crystal field potential. The introduction of Lu³⁺ at the octahedral site is confirmed by the shift of the absorption band υ2 towards lower frequencies. Additionally, as Lu³⁺ replaces Fe³⁺ ions at B-sites, fewer Fe³⁺ ions are present, leading to the shift of the band at 1 to a higher wavenumber area. The incorporation of Lu³⁺ ions induces changes in the absorption bands υ1 and υ2, resulting in structural distortion in Zn ferrites.

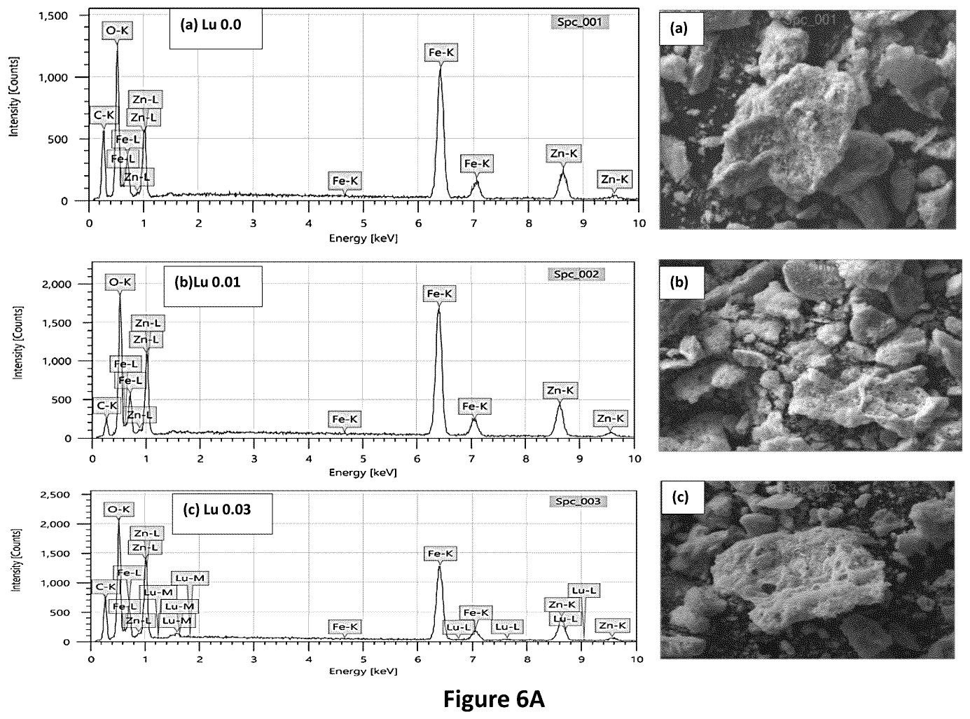

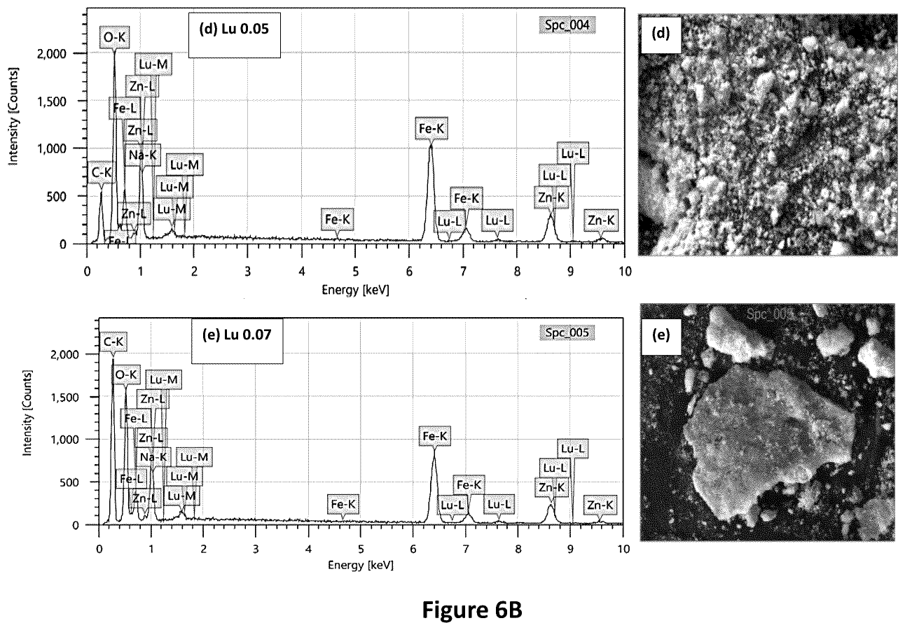

FIGS. 6A and 6B illustrates a plurality of graphs showing the SEM micrographs and EDS spectra of the Lu doped Zn ferrite in accordance with an embodiment of the present disclosure.

Referring to FIG. 6A, microstructure analysis is represented in the figure, wherein figure (a) represents Lu 0.00=ZnFe₂O₄, figure (b) represents Lu 0.01=ZnFe_{1.99}Lu_{0.01}O₄, nad figure (c) represents Lu 0.03=ZnFe_{1.97}Lu_{0.03}O₄,

Referring to FIG. 6B microstructure analysis is represented in the figure, wherein figure (d) represents Lu 0.05=ZnFe_{1.95}Lu_{0.05}O₄, and figure (e) represents Lu 0.07=ZnFe_{1.93}Lu_{0.07}O₄.

SEM analysis was employed to capture microstructural features such as grain size, pores, inclusions, grain boundaries, particle size, homogeneity, and fluxes in the synthesized samples. The utilization of SEM allows for a detailed examination of grain boundaries, and due to the smaller grain size and lower porosity, the generation of undesirable spin waves—essential for humidity sensors—is minimized. Notably, the high porosity of the samples contributes to enhanced humidity-sensing capabilities.

Elemental analysis was conducted using EDS spectra on the manufactured samples. FIG. 6b illustrates EDS spectra for all samples, confirming that the intended compositions were successfully synthesized as per the chemical equations. The agreement between theoretical and experimental stoichiometry, derived from EDS data, indicates distinct grain boundaries due to particle growth. The particles exhibit near-perfect spherical morphology, and considerable aggregation is observed across all compositions.

Quantitative insights into the presence of Fe borders are obtained through EDS patterns, wherein it can be seen quite plainly that the particles are virtually perfectly spherical, and there is considerable aggregation apparent in all of the compositions. Additionally, EDS patterns provide a detailed analysis of element concentrations, including Fe, Zn, Lu, and O, demonstrating the accuracy of the preparation process in maintaining the specified specifications. The overall SEM and EDS analyses offer valuable insights into the microstructure and elemental composition of the synthesized ferrite materials, crucial for understanding their potential in humidity sensor applications.

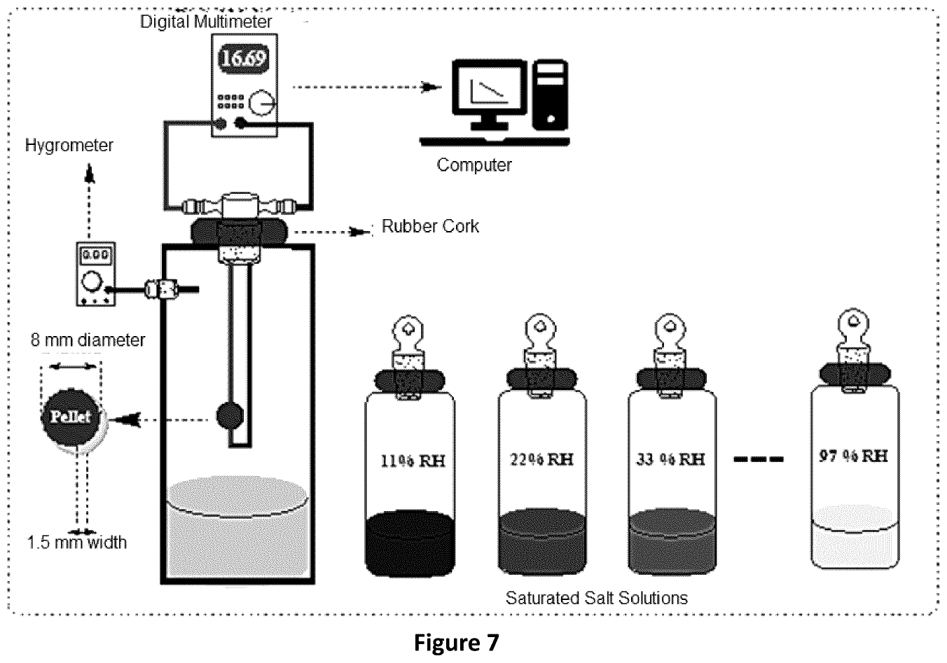

FIG. 7 illustrates a diagram showing the humidity sensing study setup in accordance with an embodiment of the present disclosure.

Referring to FIG. 7, shown humidity sensing set-up is utilized for performing humidity sensing behavior study, wherein the humidity sensing setup comprises glass chambers filled with salt solutions and is monitored using a humidity meter (Mextech-DT-615). The compartments are sealed with rubber cork electrodes. Pellet-shaped samples are connected to the electrodes using a programmable digital multimeter, Hioki DT 4282, enabling the measurement of resistance when exposed to a designated relative humidity environment at room temperature. FIG. 7 provides a visual representation of the humidity sensor setup used in the experimental humidity sensing trials.

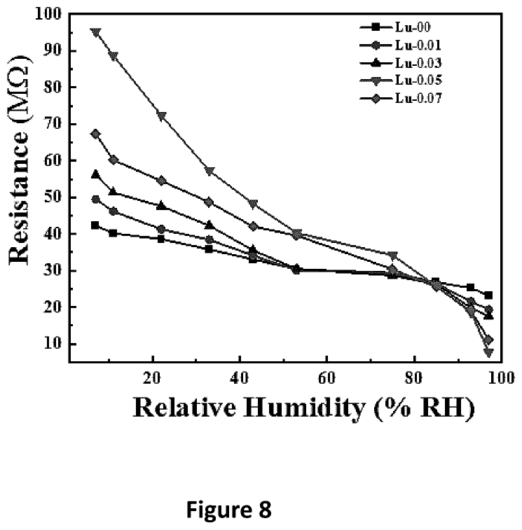

FIG. 8 illustrates a graph depicting the change in resistance versus % RH in accordance with an embodiment of the present disclosure.

In FIG. 8, the resistance versus relative humidity is depicted for Lu-doped Zn ferrite samples with different compositions of Lu. Notably, ZnFe1.95Lu0.05O4 stands out among all the samples, displaying a remarkable resistance shift and achieving an impressive sensing performance of nearly 97%. This exceptional performance can be attributed to the enhanced porosity and active surface of the nanoparticles, facilitating the absorption of water vapor and providing sites for proton interaction, consequently leading to a decrease in resistivity.

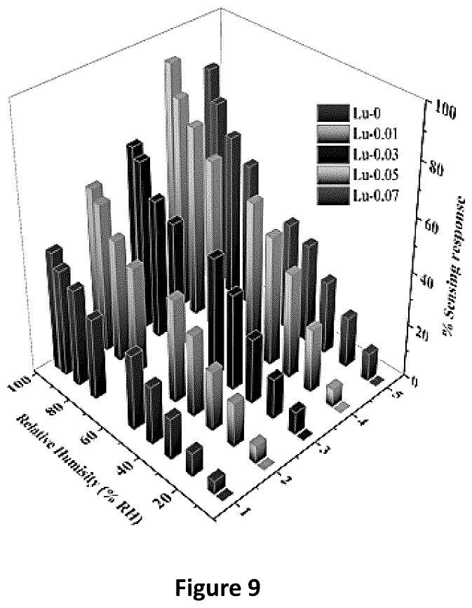

FIG. 9 illustrates a graphs depicting the sensing response of ZnFe₍₂₋ₓ₎LuₓO₄ where (X=0.00,0.01,0.03,0.05,0.07) in accordance with an embodiment of the present disclosure.

Referring to FIG. 9, the graph shown offers a comparative analysis of the sensing response variation among the different compositions.

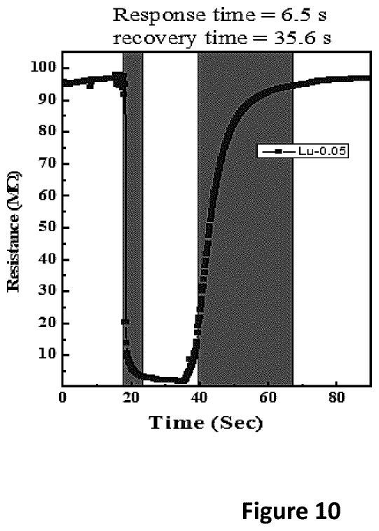

FIG. 10 illustrates a graph depicting the timing behavior of ZnFe_{1.95}Lu_{0.05}O₄ nanoparticles in accordance with an embodiment of the present disclosure.

Referring to FIG. 10, reaction and recovery timing behavior are shown, wherein to assess this, two flasks were employed, with one maintained at 11% relative humidity (RH) and the other at 97% RH. The relative humidity of each film was rapidly transitioned from 11% to 97%, and the corresponding response and recovery times were meticulously recorded. In both scenarios, the transition time was measured at 35.6 seconds. FIG. 10 illustrates the adeptly plotted reaction and recovery behaviors. Notably, the Lu 0.05 composite exhibited a 35.6-second recovery time and a 6.5-second response time. This temporal behavior is attributed to the composite's high-porosity surface and expansive surface area. The disparity in response and recovery times is a consequence of the spontaneous nature of adsorption, where breaking the bond between the adsorbent and adsorbed surface demands increased energy. The noteworthy aspect here is the rapid reaction and recovery times of the Lu 0.05 composite, contributing to its impressive sensing response.

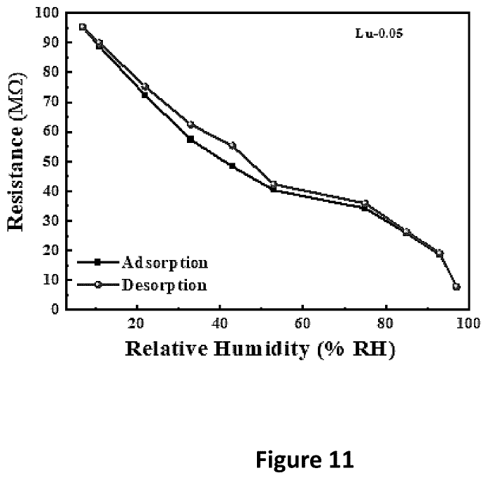

FIG. 11 illustrates a graph depicting the humidity hysteresis of the ZnFe_{1.95}Lu_{0.05}O₄ nanoparticles in accordance with an embodiment of the present disclosure.

Referring to FIG. 11, the experimental humidity hysteresis characteristics of 5 mol % substituted ZnFe₂₋ₓLuₓO₄ nanoparticles were identified within the range of 11% RH to 97% RH. The absorption curve was derived by retracing the mean values in equivalent measures, while the desorption curve exhibits a gradual increase from 11% RH to 97% RH.

Observations indicate that the absorption process tends to be slightly slower than desorption. This implies that the exothermic and endothermic responses, when compared individually during adsorption and desorption, occur at different rates, resulting in a slightly higher impedance during absorption than during desorption. The most significant humidity hysteresis, visible in the image, is approximately 3% at 55% relative humidity, and the outcomes closely align with those observed in praseodymium-doped magnesium ferrite.

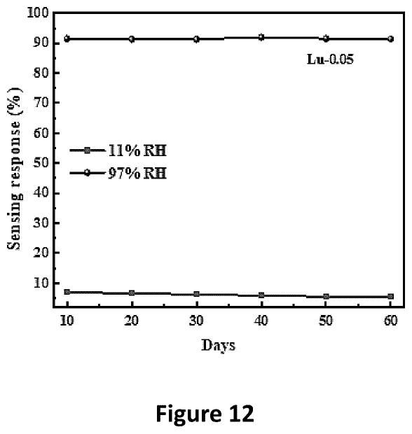

FIG. 12 illustrates a graph depicting the humidity stability of the ZnFe_{1.95}Lu_{0.05}O₄ nanoparticles in accordance with an embodiment of the present disclosure.

Over a two-month period, the stability of ZnFe_{1.95}Lu_{0.05}O₄ nanoparticles was evaluated at 10-day intervals. Referring to FIG. 12, the sensing response was determined at 11% and 97% humidity levels every 10 days, and a graph illustrating the correlation between the two variables was generated. The humidity sensing charts revealed that the ZnFe_{1.95}Lu_{0.05}O₄ nanoparticles sensor exhibits exceptional effectiveness and is well-suited for industrial applications. This is attributed to its exemplary sensitivity, maximum change in resistance, favorable response and recovery characteristics, minimal hysteresis, and sustained stability over the assessment period.

The present invention provides a method that involves the synthesis of ZnFe₍₂₋ₓ₎LuₓO₄ (Where X=0.00, 0.01, 0.03, 0.05, 0.07) (ZFL) nanoparticles through a chemical synthesis process. Stoichiometric amounts of zinc nitrate, iron nitrate, and lutetium nitrate are mixed with glucose and urea, forming a homogeneous redox mixture. This mixture undergoes combustion in a preheated muffle furnace, resulting in ZFL nanoparticles. The study confirms the production of a single-phase without impurities through XRD analysis.

The FTIR spectra exhibit characteristic spinel ferrite bands at 532 cm-1 and 360 cm-1. Scanning electron micrographs reveal nearly spherical, porous nanoparticles with uniform sizes. EDAX analysis corroborates the elemental composition of the nanoparticles. The humidity sensing performance of Lu-doped ZnFe₂O₄ is evaluated across a range of relative humidities (11-97%).

Notably, the Lu=0.05 sample demonstrates the highest sensing response at 93%, with response and recovery times of 35.6 and 6.5 seconds, respectively. The comprehensive characterization confirms the successful synthesis and excellent humidity-sensing capabilities of Lu-doped ZnFe2O4 nanoparticles, particularly the Lu=0.05 variant, highlighting its potential for industrial applications.

Lutetium-doped zinc ferrite ceramics are used in humidity sensing due to their unique properties and behavior in response to changes in humidity levels. The main applications are Humidity sensors based on lutetium-doped zinc ferrite ceramics find applications in various industries including HVAC (Heating, Ventilation, and Air Conditioning) systems, industrial process monitoring, agricultural applications, and consumer electronics. They are used to measure and control humidity levels in environments where precise humidity control is necessary for processes or comfort. Ongoing research in materials science and sensor technology continues to improve the sensitivity, reliability, and versatility of humidity sensors based on these ceramics.

Lutetium-doped zinc ferrite ceramics are used in humidity sensing due to their unique properties and behavior in response to changes in humidity levels.

Humidity Sensing Mechanism: The humidity sensing mechanism in these ceramics is based on the principle of adsorption and desorption of water molecules on the surface of the material. When exposed to humid air, water molecules are absorbed onto the surface of the ceramics, leading to changes in the electrical properties of the material.

Changes in Electrical Properties: The presence of water molecules alters the conductivity or impedance of the lutetium-doped zinc ferrite ceramics. This change in electrical properties can be measured using various techniques such as impedance spectroscopy, capacitance measurement, or resistance measurement.

Sensor Configuration: The lutetium-doped zinc ferrite ceramics are typically incorporated into a sensor device. The sensor device may include electrodes to measure the electrical properties of the ceramics and a microcontroller or signal processing unit to analyze the sensor output.

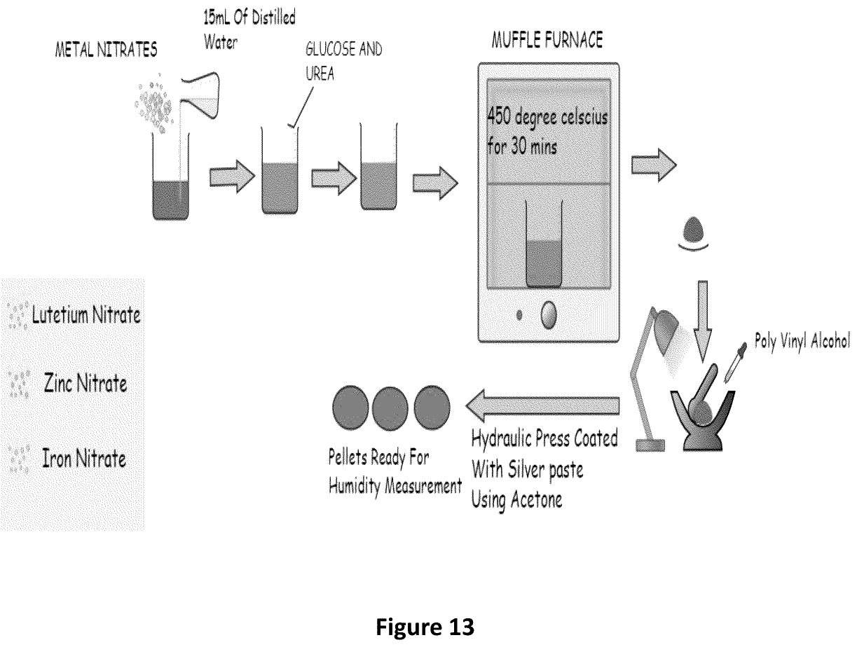

FIG. 13 illustrates a Graphical representation for the preparation of nanoparticles in accordance with an embodiment of the present disclosure.

Unfortunately, I cannot provide specific temperature and pressure values for each step of the process for manufacturing lutetium-doped zinc ferrite humidity sensors, as the exact parameters can vary based on the specific synthesis method, equipment used, and desired properties of the final product. However, I can provide general guidelines for some common steps in synthesis processes:

Nanoparticles of ZnFe(2-x)LuxO4 (Where X=0.00, 0.01, 0.03, 0.05, 0.07) were synthesized by chemical synthesis methody. To prepare them, stoichiometric molar amounts of zinc nitrate (Zn(NO3)2·6H2O), iron nitrate (Fe(NO3)2·6H2O) and lutetium nitrate (Lu(NO3)2·9H2O) were taken in a 250 ml beaker, which acted as oxidizers. Glucose and urea in 1:1 ratio were added to this along with 15 mL of distilled water, and the resultant mixture was stirred to obtain a homogeneous solution containing a redox mixture.

Next, the beakers containing all the solutions of metal nitrates and fuels were placed in a preheated muffle furnace (450° C.) for approximately 30 minutes. Initially, the solution boiled and ignited to form a gel, which then burned into powder, releasing stable gases like CO₂, N₂, H₂O.

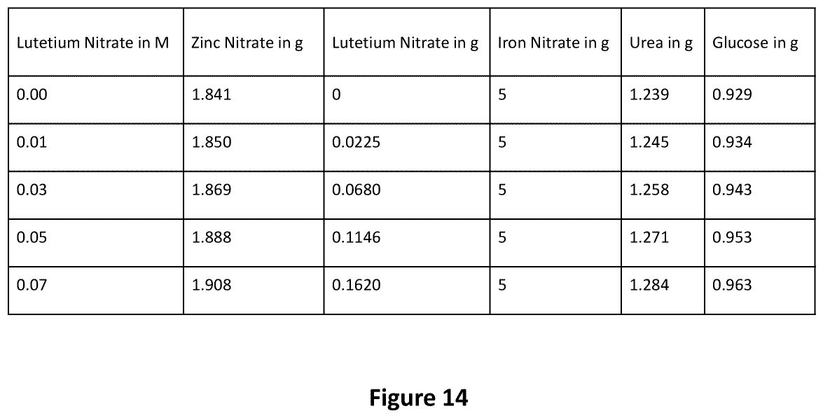

FIG. 14 illustrates a Table depicting stoichiometric amount of oxidiser and fuels used in the synthesis method in accordance with an embodiment of the present disclosure.

FIG. 15 illustrates a Table depicting the parameter of Zn Fe₂₋ₓLuₓO₄ in accordance with an embodiment of the present disclosure.

Ensuring the reproducibility and consistency of the process for preparing lutetium-doped zinc ferrite ceramics on a large scale requires careful attention to several key factors:
1. Material Selection and Characterization: Start with high-quality raw materials including zinc oxide, iron oxide, and lutetium oxide. It's crucial to characterize these materials thoroughly to ensure their purity, particle size distribution, and other relevant properties.
2. Formulation and Mixing: Develop a precise formulation recipe specifying the proportions of each raw material needed to achieve the desired composition of lutetium-doped zinc ferrite ceramics. Use efficient mixing techniques to ensure homogeneity of the mixture, which can include methods such as ball milling or dry/wet mixing.
3. Sintering Process Optimization: Sintering is a critical step in the ceramic manufacturing process where the mixed powder is heated to high temperatures to form the ceramic structure. Optimize the sintering parameters such as temperature, duration, and atmosphere to achieve uniform densification and crystal growth across batches.
4. Temperature and Atmosphere Control: Maintain tight control over the sintering temperature and atmosphere to prevent variations in the final ceramic properties. Use programmable kilns or furnaces with precise temperature control capabilities, and consider the use of protective atmospheres like nitrogen or argon to prevent oxidation or other undesirable reactions.
5. Characterization and Quality Control: Implement rigorous characterization and quality control procedures at various stages of the manufacturing process. This includes testing the raw materials, monitoring the mixing process, analyzing samples during sintering, and evaluating the properties of the final ceramics using techniques such as X-ray diffraction (XRD), scanning electron microscopy (SEM), and electrical property measurements.
6. Standard Operating Procedures (SOPs): Develop detailed SOPs outlining each step of the manufacturing process, including material handling, mixing protocols, sintering parameters, and quality control checkpoints. Train personnel thoroughly on these procedures to ensure consistency and adherence to best practices.
7. Batch-to-Batch Monitoring and Adjustment: Regularly monitor the properties of the produced ceramics across different batches to identify any trends or deviations. Establish protocols for adjusting process parameters or material formulations as needed to maintain consistency and address any observed variations.
8. Traceability and Documentation: Maintain comprehensive records of all process parameters, material specifications, and quality control data for each batch of ceramics produced. This traceability enables effective troubleshooting, root cause analysis, and continuous improvement efforts to enhance reproducibility over time.

By implementing these strategies, manufacturers can enhance the reproducibility and consistency of the process for preparing lutetium-doped zinc ferrite ceramics on a large scale, ensuring reliable performance and quality in the final products.

The variation in the ratio of lutetium (Lu) dopant in lutetium-doped zinc ferrite ceramics plays a significant role in determining the performance of humidity sensors. Here's how the ratio of lutetium can impact the properties and performance of the sensors: Sensitivity to Humidity: The incorporation of lutetium dopant influences the structural and electrical properties of the zinc ferrite ceramics. The ratio of lutetium dopant can affect the material's sensitivity to changes in humidity levels. By adjusting the lutetium concentration, researchers can optimize the sensor's sensitivity to achieve accurate and responsive humidity measurements over a wide range of humidity conditions. Electrical Conductivity: Lutetium doping alters the electrical conductivity of zinc ferrite ceramics, affecting their response to humidity variations. Higher concentrations of lutetium dopant may enhance the material's electrical conductivity, leading to improved sensor performance in terms of response time, signal-to-noise ratio, and stability. Chemical Stability: Lutetium doping can enhance the chemical stability of zinc ferrite ceramics, reducing their susceptibility to environmental factors such as moisture, temperature fluctuations, and chemical contaminants. By optimizing the lutetium ratio, researchers can enhance the long-term stability and reliability of humidity sensors, ensuring consistent performance over extended periods of operation. Crystalline Structure and Phase Formation: The ratio of lutetium dopant may influence the crystalline structure, phase composition, and microstructural characteristics of the zinc ferrite ceramics. Variations in the lutetium concentration can affect the formation of secondary phases, crystal lattice parameters, and grain boundaries, which in turn impact the material's sensing properties and response to humidity changes. Optical and Magnetic Properties: Lutetium-doped zinc ferrite ceramics may exhibit altered optical and magnetic properties compared to undoped counterparts. The ratio of lutetium dopant can modulate the material's optical transparency, magnetic susceptibility, and dielectric constant, influencing the sensing mechanism and performance of humidity sensors based on these ceramics.

To control the combustion process and ensure the formation of stable ZnFe(2-x)LuxO4 nanoparticles, several measures can be taken:
1. Precursor Selection: Careful selection of precursor materials is essential. Precursors should be chosen based on their compatibility with the desired combustion synthesis process and their ability to yield stable nanoparticles. For example, zinc acetate, iron nitrate, and lutetium nitrate may be selected as precursors for zinc, iron, and lutetium sources, respectively.
2. Stoichiometry Control: Maintaining the appropriate stoichiometry of the precursors is crucial for controlling the composition and properties of the nanoparticles. Precise control over the molar ratios of zinc, iron, and lutetium precursors ensures the desired composition of the final ZnFe(2-x)LuxO4 nanoparticles.
3. Combustion Parameters: The combustion parameters, including the nature of the fuel, oxidizer, and combustion temperature, should be optimized to promote the formation of stable nanoparticles with the desired crystalline structure. The choice of combustion parameters influences the reaction kinetics, phase formation, and morphology of the nanoparticles.
4. Fuel-to-Oxidizer Ratio: The fuel-to-oxidizer ratio plays a critical role in controlling the combustion process and subsequent nanoparticle formation. Adjusting the stoichiometry of the fuel-to-oxidizer ratio can influence the combustion temperature, flame propagation rate, and combustion efficiency, thereby affecting the characteristics of the synthesized nanoparticles.
5. Controlled Atmosphere: The atmosphere in which the combustion process takes place can influence the formation and stability of the nanoparticles. Inert gas atmospheres, such as nitrogen or argon, may be used to prevent unwanted oxidation or decomposition of the precursors during combustion.
6. Reaction Time and Temperature Control: The reaction time and temperature during the combustion process should be carefully controlled to promote the formation of stable nanoparticles with the desired crystalline structure and morphology. Optimizing these parameters helps to prevent the formation of undesirable by-products and ensures the uniformity of the nanoparticle size distribution.
7. Characterization and Quality Control: Comprehensive characterization techniques, including X-ray diffraction (XRD), scanning electron microscopy (SEM), transmission electron microscopy (TEM), and Fourier-transform infrared spectroscopy (FTIR), should be used to analyze the structural, morphological, and chemical properties of the synthesized nanoparticles. Quality control measures help ensure consistency and reproducibility in the synthesis process. By implementing these measures, researchers can effectively control the combustion process and ensure the formation of stable ZnFe(2-x)LuxO4 nanoparticles with the desired composition, structure, and properties for various applications.

Certainly, the development of processes for synthesizing ZnFe(2-x)LuxO4 nanoparticles via combustion synthesis may encounter several challenges and limitations:
1. Controlled Stoichiometry: Achieving precise control over the stoichiometry of the precursor materials, particularly when incorporating lutetium as a dopant, can be challenging. Variations in the molar ratios of the precursors may lead to deviations in the composition and properties of the synthesized nanoparticles.
2. Phase Purity and Crystallinity: Ensuring the formation of phase-pure ZnFe(2-x)LuxO4 nanoparticles with high crystallinity can be difficult, especially during the rapid and exothermic combustion process. Contaminants, impurities, or secondary phases may form due to incomplete combustion, improper stoichiometry, or inadequate post-treatment procedures.
3. Particle Size and Morphology Control: Controlling the particle size distribution and morphology of the synthesized nanoparticles poses challenges, as the combustion process often yields nanoparticles with varying sizes, shapes, and surface properties. Achieving uniformity in particle size and morphology is essential for optimizing the performance of the nanoparticles in specific applications.
4. Agglomeration and Stability: Nanoparticle agglomeration and instability can occur during the synthesis process or upon storage, leading to changes in the physical and chemical properties of the nanoparticles. Preventing agglomeration and ensuring long-term stability require careful control over processing parameters, surface functionalization, and storage conditions.
5. Reproducibility and Scalability: Achieving reproducibility and scalability in the synthesis process is crucial for translating laboratory-scale methods to industrial production. Variations in precursor materials, combustion parameters, and post-treatment procedures can affect the reproducibility and scalability of the synthesis process, necessitating systematic optimization and standardization.

Identifying specific markets or industries where lutetium-doped zinc ferrite humidity sensors could be particularly valuable involves understanding the unique characteristics and advantages of these sensors and how they align with the needs of various applications. Here are some industries and markets where such humidity sensors could find significant value:
1. HVAC (Heating, Ventilation, and Air Conditioning): Humidity control is critical in HVAC systems to maintain indoor air quality, prevent mold growth, and ensure occupant comfort. Lutetium-doped zinc ferrite humidity sensors offer high sensitivity and accuracy, making them suitable for integration into HVAC systems for precise humidity monitoring and control.
2. Industrial Process Monitoring and Control: Many industrial processes, such as pharmaceutical manufacturing, food processing, and semiconductor fabrication, require precise humidity control to ensure product quality and consistency. Lutetium-doped zinc ferrite humidity sensors can be used for real-time monitoring and control of humidity levels in various industrial environments.
3. Agriculture and Greenhouse Management: Humidity plays a crucial role in plant growth, disease prevention, and crop yield optimization in agricultural settings and greenhouses. Humidity sensors can help farmers and greenhouse operators monitor and regulate humidity levels to create optimal growing conditions. Lutetium-doped zinc ferrite sensors offer the sensitivity and reliability required for agriculture applications.
4. Consumer Electronics: Humidity sensors are increasingly being integrated into consumer electronics devices such as smart thermostats, weather stations, and wearable health trackers. Lutetium-doped zinc ferrite sensors can provide accurate humidity measurements in compact and energy-efficient form factors, making them suitable for integration into various consumer electronics products.
5. Automotive Industry: Humidity control is essential for maintaining cabin comfort and preventing fogging on vehicle windows. Humidity sensors integrated into automotive HVAC systems can help regulate interior humidity levels and enhance driving comfort and safety. Lutetium-doped zinc ferrite sensors may find applications in automotive climate control systems.
6. Environmental Monitoring: Humidity sensors are used in environmental monitoring applications to assess indoor and outdoor air quality, track weather patterns, and study climate change. Lutetium-doped zinc ferrite sensors can contribute to environmental monitoring efforts by providing accurate humidity data for research and analysis.

Continual optimization and refinement of the process for manufacturing lutetium-doped zinc ferrite humidity sensors are essential to enhance their performance, reliability, and efficiency. Here are some potential areas for further optimization and refinement: Material Composition: Fine-tuning the composition of lutetium-doped zinc ferrite ceramics can optimize their electrical and sensing properties. Researchers may explore different doping levels, dopant distribution, or alternative dopants to improve sensitivity, response time, and stability of the sensors. Nanostructuring: Implementing nanostructuring techniques such as nanoparticle size control, surface modification, or nanostructuring of the sensing material can enhance the sensor's surface area-to-volume ratio, leading to improved sensitivity and response characteristics. Surface Functionalization: Surface functionalization techniques can be employed to modify the surface chemistry of the sensing material, enhancing its interaction with water molecules and improving the sensor's selectivity, specificity, and response to humidity changes. Advanced Fabrication Techniques: Exploring advanced fabrication techniques such as sol-gel processing, chemical vapor deposition (CVD), or atomic layer deposition (ALD) can enable precise control over the morphology, crystallinity, and microstructure of the sensing material, resulting in sensors with enhanced performance and reliability. Energy Efficiency: Optimizing the sensor's energy consumption by reducing power requirements, implementing low-power sensing techniques, or developing energy harvesting mechanisms can extend battery life and improve the overall efficiency of battery-operated sensor devices. Environmental Stability: Enhancing the sensor's resistance to environmental factors such as temperature variations, humidity extremes, and chemical contaminants can improve its long-term stability, reliability, and durability in harsh operating conditions.

### ACKNOWLEDGMENT

The authors extend their appreciation to University Higher Education Fund for funding this research work under Research Support Program for Central labs at King Khalid University through the project number CL/RP/8.

The drawings and the forgoing description give examples of embodiments. Those skilled in the art will appreciate that one or more of the described elements may well be combined into a single functional element. Alternatively, certain elements may be split into multiple functional elements. Elements from one embodiment may be added to another embodiment. For example, orders of processes described herein may be changed and are not limited to the manner described herein. Moreover, the actions of any flow diagram need not be implemented in the order shown; nor do all of the acts necessarily need to be performed. Also, those acts that are not dependent on other acts may be performed in parallel with the other acts. The scope of embodiments is by no means limited by these specific examples. Numerous variations, whether explicitly given in the specification or not, such as differences in structure, dimension, and use of material, are possible. The scope of embodiments is at least as broad as given by the following claims.

Benefits, other advantages, and solutions to problems have been described above with regard to specific embodiments. However, the benefits, advantages, solutions to problems, and any component(s) that may cause any benefit, advantage, or solution to occur or become more pronounced are not to be construed as a critical, required, or essential feature or component of any or all the claims.

1. A composition for preparing lutetium-doped zinc ferrite ceramics for humidity sensor application, the composition comprises:
30-35 wt. % of zinc nitrate (Zn(NO₃)₂·6H₂O);
30-35 wt. % of iron nitrate (Fe(NO₃)₂·6H₂O);
30-35 wt. % of lutetium nitrate (Lu(NO₃)₂·9H₂O);
45-55 wt. % of glucose;
45-55 wt. % of urea; and
0-10 wt. % of distilled water.

2. The composition of claim 1, wherein the weight percentage of the zinc nitrate (Zn(NO₃)₂·6H₂O), iron nitrate (Fe(NO₃)₂·6H₂O), lutetium nitrate (Lu(NO₃)₂·9H₂O), glucose, and urea is 33.33%, 33.33%, and 33.33%, 50%, and 50%, respectively, wherein the distilled water is preferably 15 mL.

3. A process for preparing composition of claim 1, the process comprises:
mixing stoichiometric molar amounts of 30-35 wt. % of zinc nitrate (Zn(NO₃)₂·6H₂O), 30-35 wt. % of iron nitrate (Fe(NO₃)₂·6H₂O), and 30-35 wt. % of lutetium nitrate (Lu(NO₃)₂·9H₂O) in a 250 ml beaker to obtain a mixture;
adding glucose and urea in a 1:1 ratio to the mixture;
adding 15 mL of distilled water to the mixture and stirring to obtain a homogeneous solution containing a redox mixture; and
placing the beaker containing the solution in a preheated muffle furnace at 450° C. for approximately 30 minutes for a gel formation which subsequently burns into powder, releasing stable gases such as CO₂, N₂, and H₂O.

4. The process of claim 3, wherein the ratio of lutetium (Lu) varies from 0.00 to 0.07.

5. The process of claim 3, wherein the gel formation and subsequent powder formation occur due to the combustion of the redox mixture composed of metal nitrates, glucose, and urea, wherein combustion parameters, including nature of fuel, oxidizer, and combustion temperature, are optimized to promote formation of stable nanoparticles.

6. The process of claim 3, wherein the preheated muffle furnace facilitates the combustion process leading to the formation of ZnFe₍₂₋ₓ₎LuₓO₄ (Where X=0.00, 0.01, 0.03, 0.05, 0.07) (ZFL) nanoparticles.

7. The process of claim 3, wherein the zinc nitrate (Zn(NO₃)₂·6H₂O), iron nitrate (Fe(NO₃)₂·6H₂O), and lutetium nitrate (Lu(NO₃)₂·9H₂O) is preferably in a 1:1:1 ratio, wherein the glucose and urea are preferably in a 1:1 ratio.

8. The process of claim 3, wherein the homogeneous solution is stirred using a magnetic stirrer at 500 rpm for 15 minutes, wherein the distilled water added to the mixture is deionized and has a conductivity of less than 0.1 μS/cm, wherein the mixture is subjected to ultrasonic agitation for 5 minutes before adding the distilled water to ensure complete dissolution of nitrates, and wherein the muffle furnace is equipped with a thermocouple to monitor and control the temperature precisely at 450° C., and wherein the gel formation occurs within the first 15 minutes of heating in the muffle furnace.

9. The process of claim 3, further comprising the step of aging the homogeneous solution at room temperature for 24 hours prior to combustion to enhance the homogeneity of the mixture and improve the uniformity of the final nanoparticles.

10. The process of claim 3, wherein the glucose and urea are dissolved separately in distilled water and then sequentially added to the metal nitrate mixture under continuous stirring at 300 rpm to ensure even distribution of the fuel and oxidizer components, and wherein the combustion process in the muffle furnace is conducted in a stepwise manner, starting with an initial heating at 200° C. for 10 minutes followed by a ramp-up to 450° C. to ensure controlled decomposition and combustion of the redox mixture.

11. The process of claim 3, further comprising subjecting the beaker containing the redox mixture to ultrasonic agitation for 15 minutes before placing it in the muffle furnace to break down any agglomerates and ensure a more homogeneous solution, and ball milling the calcined powder in a high-energy planetary ball mill for 3 hours at a speed of 400 rpm using zirconia balls to achieve a narrow particle size distribution and enhance the surface area.

12. The process of claim 3, wherein the ball-milled powder is subjected to a secondary calcination step at 700° C. for 2 hours in an inert atmosphere to further enhance the crystallinity and phase stability of the nanoparticles.

13. The process of claim 3, further comprising pressing the ball-milled and calcined powder into cylindrical pellets using a uniaxial hydraulic press at a pressure of 500 MPa, followed by sintering in a box furnace at 950° C. for 6 hours with a heating rate of 5° C./min, and wherein the obtained nanoparticles are dispersed in ethanol and subjected to sonication for 30 minutes to achieve a stable colloidal suspension, followed by drop-casting onto interdigitated electrodes to fabricate a prototype humidity sensor.

14. The process of claim 3, wherein the synthesized ZnFe(2-x)LuxO4 nanoparticles are functionalized with a silane coupling agent including 3-Aminopropyltriethoxysilane to improve the adhesion and stability of the nanoparticles on the sensor substrate.

15. The process of claim 3, further comprises cooling the obtained powder to room temperature after the combustion process is complete, wherein the combustion process is conducted under an inert atmosphere to prevent oxidation of the nanoparticles, and wherein process further comprises washing and drying the obtained nanoparticles to remove any residual impurities or by-products.
